(19) United States
(12) Patent Application Publication
(10) Pub. No.: US 2017/0267886 A1
(43) Pub. Date: Sep. 21, 2017

(54) AQUEOUS INKJET INK CONTAINING POLYMERIC BINDERS

(71) Applicant: E I DU PONT DE NEMOURS AND COMPANY, Wilmington, DE (US)

(72) Inventor: Waifong Liew Anton, Wilmington, DE (US)

(21) Appl. No.: 15/532,318

(22) PCT Filed: Dec. 11, 2015
(86) PCT No.: PCT/US2015/065179

§ 371 Date: Jun. 1, 2017

Related U.S. Application Data
(60) Provisional application No. 62/094,136, filed on Dec. 19, 2014.

(51) Int. Cl. C09D 11/326; C09D 11/107; C09D 11/40; C09D 11/38

(52) U.S. Cl. CPC C09D 11/326; C09D 11/38; C09D 11/107; C09D 11/40

(57) ABSTRACT

The present disclosure provides an ink for inkjet printing on offset media. The inkjet ink comprises a dispersed binder. The binder is present at a concentration of greater than 3% by weight.

### CROSS REFERENCE TO RELATED APPLICATIONS

This application claims priority under 35 U.S.C. §119 from U.S. Provisional Application Ser. No. 62/094,136, filed Dec. 19, 2014, which is incorporated by reference in its entirety.

### BACKGROUND OF THE DISCLOSURE

This disclosure pertains to an aqueous inkjet ink, in particular to an aqueous inkjet ink for printing on offset media. The ink contains a dispersed binder that is present at a concentration of greater than 3% by weight.

Inkjet printing is a non-impact printing process in which droplets of ink are deposited on a substrate, such as paper, to form the desired image. Inkjet printers are equipped with an ink set which, for full color printing, typically comprises a cyan, magenta and yellow ink (CMY). An ink set also typically comprises a black ink (CMYK) with the black ink being the most common ink.

Fast onset of durability is important for inkjet printing, it is often necessary for the recently printed-article to come into contact with the paper-handling mechanism of the printer, e.g., in the case of duplex printing where both sides of the media are printed. In this case the first printed side may not yet be completely dry and as a result the print surface can be damaged and the ink can transfer onto the paper-handling mechanism and then onto subsequent prints. This problem is particularly acute when using a web-press which involves considerable paper-handling at high speeds. Often the press uses heated rollers to transfer media which is prone to having problems as the drying ink sticks to the rollers. Severe problems may be encountered when slow-drying inks are printed onto non- or low-absorbent media such as coated offset media.

Coated media traditionally has been printed with inks that are very high in viscosity and/or are solvent-based inks. Aqueous inkjet inks are usually low in viscosities resulting in greater mobility of pigments during drying. In addition, aqueous inkjet ink requires longer de-wetting time after printing on hydrophobic coated media. Thus, aqueous inkjet inks often have poor image quality such as mottle from non-uniform deposition of colorant and low color when printed on coated media.

A need still exists for aqueous inkjet ink that provides fast on set of print durability and good printing quality for printing on offset media. The present disclosure satisfies this need by providing ink compositions containing a dispersed binder.

### SUMMARY OF THE DISCLOSURE

An embodiment provides an inkjet ink for printing on a coated media substrate, said inkjet ink comprising a colorant, an aqueous vehicle, a polymeric binder and a non-ionic surfactant, wherein said binder is dispersed in the aqueous vehicle and is present at an amount of greater than 3% by weight based on the weight of the ink.

Another embodiment provides that the binder is a polyurethane.

Another embodiment provides that the polyurethane is cross-linked.

Another embodiment provides that the binder is acrylics.

Another embodiment provides that the binder is neutralized by an amine.

Another embodiment provides that the colorant is an organic pigment.

Another embodiment provides that the colorant is a self-dispersing pigment.

Another embodiment provides that the colorant is dispersed by a polymeric dispersant.

Another embodiment provides that the colorant is dispersed by a polymeric dispersant followed by crosslinking the dispersant.

Another embodiment provides that the ink further comprises a co-solvent at an amount of greater than 25% based the total weight of the ink.

Another embodiment provides that the co-solvent is present at an amount of greater than 30% based the total weight of the ink.

Another embodiment provides that the non-ionic surfactant has an HLB value of 8 or lower.

Another embodiment provides that the non-ionic surfactant has an HLB value of 4 or lower.

Another embodiment provides that the ink has a surface tension of between 18 and 35 dyne/cm.

Yet another embodiment provides that the ink has a viscosity of between 3 centipoise and 8 centipoise.

These and other features and advantages of the present embodiments will be more readily understood by those of ordinary skill in the art from a reading of the following Detailed Description. Certain features of the disclosed embodiments which are, for clarity, described above and below as separate embodiments, may also be provided in combination in a single embodiment. Conversely, various features of the disclosed embodiments that are described in the context of a single embodiment, may also be provided separately or in any subcombination.

### DETAILED DESCRIPTION

Unless otherwise stated or defined, all technical and scientific terms used herein have commonly understood meanings by one of ordinary skill in the art to which this disclosure pertains.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

When the term “about” is used in describing a value or an end-point of a range, the disclosure should be understood to include the specific value or end-point referred to.

As used herein, the term “dispersion” means a two phase system wherein one phase consists of finely divided particles (often in a colloidal size range) distributed throughout a bulk substance, the particles being the dispersed or internal phase and the bulk substance being the continuous or external phase.

As used herein, the term “dispersant” means a surface active agent added to a suspending medium to promote uniform and maximum separation of extremely fine solid particles often of colloidal sizes. For pigments, the dispersants are most often polymeric dispersants, and the dispersants and pigments are usually combined using a dispersing equipment.

As used herein, the term “aqueous vehicle” refers to water or a mixture of water and at least one water-soluble, or partially water-soluble (i.e., methyl ethyl ketone), organic solvent (co-solvent).

As used herein, the term “substantially” means being of considerable degree, almost all.

As used herein, the term “dyne/cm” means dyne per centimetre, a surface tension unit.

As used herein, the term “cP” means centipoise, a viscosity unit.

The materials, methods, and examples herein are illustrative only except as explicitly stated, and are not intended to be limiting.

### Aqueous Vehicle

Selection of a suitable aqueous vehicle mixture depends on requirements of the specific application, such as the desired surface tension and viscosity, the selected colorant, drying time of the ink, and the type of substrate onto which the ink will be printed. Representative examples of water-soluble organic solvents which may be utilized in the present disclosure are those that are disclosed in U.S. Pat. No. 5,085,698.

If a mixture of water and a water-soluble solvent is used, the aqueous vehicle typically will contain about 30% to about 95% of water with the remaining balance (i.e., about 70% to about 5%) being the water-soluble solvent. Compositions of the present disclosure may contain about 60% to about 95% water, based on the total weight of the aqueous vehicle.

The amount of aqueous vehicle in the ink is typically in the range of about 70% to about 99.8%; specifically about 80% to about 99.8%, based on total weight of the ink.

The non-ionic surfactant is typically present at an amount of from about 0.01% to about 5%, and specifically from about 0.2% to about 2%, based on the total weight of the ink.

### Pigments

The term “pigment” as used herein means an insoluble colorant that requires to be dispersed with a dispersant and processed under dispersive conditions in the presence of a dispersant. The colorant also includes dispersed dyes. The dispersion process results in a stable dispersed pigment.

The selected pigment(s) may be used in dry or wet form. For example, pigments are usually manufactured in aqueous media, and the resulting pigments are obtained as a water-wet presscake. In presscake form, the pigment does not agglomerate to the extent it would in dry form. Thus, pigments in water-wet presscake form do not require as much mixing energy to de-agglomerate in the premix process as pigments in dry form. Representative commercial dry pigments are listed in U.S. Pat. No. 5,085,698.

Some examples of pigments with coloristic properties useful in inkjet inks include: cyan pigments from Pigment Blue 15:3 and Pigment Blue 15:4; magenta pigments from Pigment Red 122 and Pigment Red 202; yellow pigments from Pigment Yellow 14, Pigment Yellow 95, Pigment Yellow 110, Pigment Yellow 114, Pigment Yellow 128 and Pigment Yellow 155; red pigments from Pigment Orange 5, Pigment Orange 34, Pigment Orange 43, Pigment Orange 62, Pigment Red 17, Pigment Red 49:2, Pigment Red 112. Pigment Red 149, Pigment Red 177, Pigment Red 178, Pigment Red 188, Pigment Red 255 and Pigment Red 264; green pigments from Pigment Green I, Pigment Green 2, Pigment Green 7 and Pigment Green 36; blue pigments from Pigment Blue 60, Pigment Violet 3, Pigment Violet 19, Pigment Violet 23, Pigment Violet 32, Pigment Violet 36 and Pigment Violet 38; white pigments such as TiO₂ and ZnO; and black pigment carbon black. The pigment names and abbreviations used herein are the “C.I.” designation for pigments established by Society of Dyers and Colourists, Bradford, Yorkshire, UK and published in The Color Index. Third Edition, 1971.

The pigment of the present disclosure can also be a self-dispersing (or self-dispersible) pigment. The term self-dispersing pigment (or “SDP”) refers to pigment particles whose surface has been chemically modified with hydrophilic, dispersability-imparting groups that allow the pigment to be stably dispersed in an aqueous vehicle without a separate dispersant. “Stably dispersed” means that the pigment is finely divided, uniformly distributed and resistant to particle growth and flocculation.

The SDPs may be prepared by grafting a functional group or a molecule containing a functional group onto the surface of the pigment, by physical treatment (such as vacuum plasma), or by chemical treatment (for example, oxidation with ozone, hypochlorous acid or the like). A single type or a plurality of types of hydrophilic functional groups may be bonded to one pigment particle. The hydrophilic groups are carboxylate or sulfonate groups which provide the SDP with a negative charge when dispersed in aqueous vehicle. The carboxylate or sulfonate groups are usually associated with monovalent and/or divalent cationic counter-ions. Methods of making SDPs are well known and can be found, for example, in U.S. Pat. No. 5,554,739 and U.S. Pat. No. 6,852,156.

The SDPs may be black, such as those based on carbon black, or may be colored pigments. Examples of pigments with coloristic properties useful in inkjet inks include: Pigment Blue 15:3 and Pigment Blue 15:4 (for cyan); Pigment Red 122 and Pigment Red 202 (for magenta). Pigment Yellow 14, Pigment Yellow 74, Pigment Yellow 95, Pigment Yellow 110, Pigment Yellow 114, Pigment Yellow 128 and Pigment Yellow 155 (for yellow); Pigment Orange 5, Pigment Orange 34, Pigment Orange 43, Pigment Orange 62, Pigment Red 17, Pigment Red 49:2. Pigment Red 112, Pigment Red 149, Pigment Red 177, Pigment Red 178. Pigment Red 188, Pigment Red 255 and Pigment Red 264 (for red); Pigment Green 1, Pigment Green 2, Pigment Green 7 and Pigment Green 36264 (for green); Pigment Blue 60, Pigment Violet 3, Pigment Violet 19, Pigment Violet 23, Pigment Violet 32, Pigment Violet 36 and Pigment Violet 38 (for blue); and carbon black. However, some of these pigments may not be suitable for preparation as SDP. Colorants are referred to herein by their “C.I.”.

The SDPs of the present disclosure may have a degree of functionalization wherein the density of anionic groups is less than about 3.5 μmoles per square meter of pigment surface (3.5 μmol/m²), and more specifically, less than about 3.0 μmol/m². Degrees of functionalization of less than about 1.8 μmol/m², and more specifically, less than about 1.5 μmol/m², are also suitable and may be preferred for certain specific types of SDPs.

The range of useful particle size after dispersion is typically from about 0.005 micrometers to about 15 micrometers. Typically, the pigment particle size should range from about 0.005 micrometers to about 5 micrometers; and, specifically, from about 0.005 micrometers to about 1 micrometers. The average particle size as measured by dynamic light scattering is less than about 500 nm, typically less than about 300 nm.

The amount of pigment present in the ink is typically in the range of from about 0.1% to about 25% by weight, and more typically in the range of from about 0.5% to about 10% by weight, based on the total weight of ink. If an inorganic pigment is selected, the ink will tend to contain higher percentages by weight of pigment than with comparable inks employing organic pigment, since inorganic pigments generally have higher densities than organic pigments.

### Polymeric Dispersant

The polymeric dispersant for the non-self-dispersing pigment(s) may be a random or a structured polymer. Typically, the polymer dispersant is a copolymer of hydrophobic and hydrophilic monomers. The “random polymer” means polymers where molecules of each monomer are randomly arranged in the polymer backbone. For a reference on suitable random polymeric dispersants, see: U.S. Pat. No. 4,597,794. The “structured polymer” means polymers having a block, branched, graft or star structure. Examples of structured polymers include AB or BAB block copolymers such as the ones disclosed in U.S. Pat. No. 5,085,698; ABC block copolymers such as the ones disclosed in EP Patent Specification No. 0556649, and graft polymers such as the ones disclosed in U.S. Pat. No. 5,231,131. Other polymeric dispersants that can be used are described, for example, in U.S. Pat. No. 6,117,921. U.S. Pat. No. 6,262,152, U.S. Pat. No. 6,306,994 and U.S. Pat. No. 6,433,117.

The “random polymer” also includes polyurethanes. Particularly useful are the polyurethane dispersant disclosed in U.S. Patent Application Publication No. 2012/0214939 where the polyurethane dispersant is crosslinked after dispersing a pigment to form a pigment dispersion.

### Polymeric Binder

The ink of the present disclosure can contain polymeric binder. Typically the polymeric binder is a polyurethane such as the ones described in publication WO 2009/143418. The binder of the present disclosure also include the cross-linked polyurethane binders disclosed in U.S. Patent Application Publication No. 20050182154, which is incorporated by reference herein as if fully set forth, under the section entitled “Polyurethane Dispersoid Binders (PUDs)”. Typically a binder is different from the polyurethane dispersant described above and non-reactive to the colorant. The binder is typically added to an ink during the final formulation stage, not during the preparation of a pigment dispersion.

### Other Additives

Other ingredients, additives, may be formulated into the inkjet ink, to the extent that such other ingredients do not interfere with the stability and jettability of the inkjet ink. This may be readily determined by routine experimentation by one skilled in the art.

Surfactants are commonly added to inks to adjust surface tension and wetting properties. Suitable surfactants include the ones disclosed in the Vehicle section above. Surfactants are typically used in amounts up to about 3% and more typically in amounts up to 1% by weight, based on the total weight of the ink.

Inclusion of sequestering (or chelating) agents such as ethylenediaminetetraacetic acid, iminodiacetic acid, ethylenediamine-di(o-hydroxyphenylacetic acid), nitrilotriacetic acid, dihydroxyethylglycine, trans-1,2-cyclohexanediaminetetraacetic acid, diethylenetriamine-N,N,N′,N″,N″-pentaacetic acid, and glycoletherdiamine-N,N,N′,N′-tetraacetic acid, and salts thereof, may be advantageous, for example, to eliminate deleterious effects of heavy metal impurities.

### Ink Sets

The term “ink set” refers to all the individual inks or other fluids an inkjet printer is equipped to jet. Ink sets typically comprise at least three differently colored inks. For example, a cyan (C), magenta (M) and yellow (Y) ink forms a CMY ink set. More typically, an ink set includes at least four differently colored inks, for example, by adding a black (K) ink to the CMY ink set to form a CMYK ink set. The magenta, yellow and cyan inks of the ink set are typically aqueous inks, and may contain dyes, pigments or combinations thereof as the colorant. Such other inks are, in a general sense, well known to those of ordinary skill in the art.

In addition to the typical CMYK inks, an ink set may further comprise one or more “gamut-expanding” inks, including differently colored inks such as an orange ink, a green ink, a red ink and/or a blue ink, and combinations of full strength and light strength inks such as light cyan and light magenta. Such other inks are, in a general sense, known to one skilled in the art.

A typical ink set comprises a magenta, yellow, cyan and black ink, wherein the black ink is an ink according to the present disclosure comprising an aqueous vehicle and a self-dispersing carbon black pigment. Specifically, the colorant in each of the magenta, yellow and cyan inks is a dye.

### Ink Properties

Jet velocity, separation length of the droplets, drop size and stream stability are greatly affected by the surface tension and the viscosity of the ink. Pigmented ink jet inks typically have a surface tension in the range of about 18 dyne/cm to about 35 dyne/cm at 25° C. Viscosity can be as high as 30 cP at 25° C., but is typically much lower, more typically less than 10 cP at 25° C. The ink has physical properties compatible with a wide range of ejecting conditions, i.e., driving frequency of the piezo element or ejection conditions for a thermal head for either a drop-on-demand device or a continuous device, and the shape and size of the nozzle. The inks should have excellent storage stability for long periods so as not to clog to a significant extent in an ink jet apparatus. Furthermore, the ink should not corrode parts of the ink jet printing device it comes in contact with, and it should be essentially odorless and non-toxic.

### Substrate

The inks of the present disclosure can be printed on common print substrate such as paper and textile. The inks of the present disclosure is most advantageous for printing on low porosity media such as offset paper and coated paper.

Offset paper and coated paper are generally known to have poor receptivity to aqueous ink jet inks. These papers have low surface porosity due to calendaring and/or application of one or more layers of hydrophobic coating layers. Such surface smoothing procedures and coatings provide papers that can withstand the high tack of traditional printing paste and/or be receptive to hydrophobic toner particles. However, the resultant low porosity means less channels for the ink vehicle to access which results in a greater dependency on ink drying by evaporation. Furthermore, the hydrophobic nature of the coating layers cause reduced wetting out and spreading out of an aqueous inks upon printing which can then lead to puddling of ink drops on the media surface. The combined effect of less dot spread and slower drying leads to many more image defects when printing aqueous inks directly on offset media. The most obvious defects include non-uniform deposition of colorants on these media. These non-uniform deposition of colorants defects are known variously as mottle or coalescence or framing or edge of the square effect. Another equally unacceptable outcome due to hydrophobicity and low porosity of offset media is increased drying time of an ink which translates to increased time for adjacent colors to co-mingle leading to inter-color bleed where one color diffuses into its neighboring color. These image defects can be mitigated by application of a chemical pre-coating or pre-treatment, often colorless, that interacts with the wet ink drops to immobilize the colorants. Being immobilized chemically, the image defects of non-uniform coloration or movement of colorants in inter-color bleed can be resolved effectively. However, use of pre-coats and pre-treatments have many disadvantages including increased cost of materials, drying energy and lowered gloss and even lowered durability of the image. Thus there is a great need to being able to achieve good color uniformity and good inter-color bleed through attention to formulation of the inks that can eliminate the need for pre-coating. The ink formulations of the present disclosure allow direct printing of aqueous inks, without necessitating the application of pre-coating or pre-treatment, on offset media.

### Examples

The invention is further illustrated by, but not limited to, the following examples, in which parts and percentages are by weight unless otherwise noted.

### Cyan Pigment Dispersion A

Dispersion A was prepared according to procedure disclosed in U.S. Patent Application Publication No. 2012/0214939, the disclosure of which is incorporated by reference herewith for all purposes as if fully set forth. A cyan TRB2 pigment was employed, and the dispersant was crosslinked after dispersing the pigment.

### Yellow Pigment Dispersion B

Dispersion B was prepared in a similar fashion as Dispersion A with the exception of using yellow pigment PY74.

### Magenta Pigment Dispersion C

Dispersion B was prepared in a similar fashion as Dispersion A with the exception of using magenta pigment PR122.

### Polymer Binder A

Binder A was prepared according to methods described in U.S. Pat. No. 5,219,916 having a monomer composition, by weight ratio, of 26.5% methyl methacrylate; 15% styrene; 50% 2-ethylhexyl acrylate (2-EHA); 2.5% N-methylol methacrylamide; 3% hydroxyethyl acrylate; and 3% methacrylic acid.

It was neutralized with potassium hydroxide to form the potassium salt and had a weight average molecular weight of about 500,000-1,250,000. It was recovered as an aqueous slurry of about 35.7 weight % polymer solids in water.

### Polymer Binder B

Binder B was prepared as for Binder A. In place of potassium hydroxide, it was neutralized with ammonia to form an ammonium salt.

### Polymer Binder C

Binder C was prepared as for Binder A. In place of potassium hydroxide, it was neutralized with dimethylethanol amine (DMEA) to form the dimethylethanol amino-salt.

### Polymer Binder D

Binder D was prepared as for Binder A. In place of potassium hydroxide, it was neutralized with 1,8-Diazabicycloundec-7-ene (DBU) to form the DBU amino-salt.

Polymer Binder E

Binder E was prepared as for Binder A. In place of potassium hydroxide, it was neutralized with Dimethylisopranol amine (DMIPA) to form the dimethylisopranol amino-salt.

### Polymer Binder F

To a dry, alkali- and acid-free flask, equipped with an addition funnel, a condenser, stirrer and a nitrogen gas line was added Desmophen® C1200 (392 g), MDEA (17 g), acetone (190 g) and 0.02 g DBTL. The contents were heated to 40° C. and mixed well. IPDI (147 g) was then added to the flask via the addition funnel with any residual IPDI being rinsed from the addition funnel into the flask with 10 g acetone.

The flask temperature was raised to 50° C., held for 60 minutes then followed by DMPA (28 g), then followed by TEA (16.5 g), addition to the flask via the addition funnel, which was then rinsed with acetone (10 g). The flask temperature was then raised again to 50° C. and held at 50° C. until NCO % was 1.3% or less.

With the temperature at 50° C., deionized water (962 g) was added over 10 minutes, followed by TETA solution (63 g as 10.5 wt % solution in water) over 5 minutes, via the addition funnel. The mixture was held at 50° C. for 1 hour then cooled to room temperature.

Acetone (210 g) was removed under vacuum, leaving a final dispersion of polyurethane with about 35.0% solids by weight. Acid number of Binder F is 21 grams of KOH per 100 g of polymer solid, pH is 8.27 and % THF insoluble is 87%.

### Preparation and Evaluation of Inks

Inks were prepared by combining ingredients as described in tables below. The inks were printed out of a Ricoh Aficio GX e5550N printer.

Printing was done on various coated media commonly used in offset, toner and other non-ink jet printing processes. These papers are exemplified by Mohawk Gloss 50/1 (Mohawk Fine Papers, US), TerraPress Silk (Stora Enso, Finland), UPM Finesse Gloss (UPM, Finland), OK Topcoat+(Oji, Japan), New Age (Oji, Japan), and LumiArt Gloss (Stora Enso, Finland).

Printing was also done on plain paper, exemplified by Xerox 4200 Business paper.

After printing, the images were left to dry for at least an hour at ambient conditions before subjecting to evaluation of color, optical density and image quality.

Uniformity of image was assessed visually. A rating scale of 1 to 5 was employed. A rating of 5 indicates perfectly uniform distribution of colorants across the printed area. A rating of 1 indicates large degree of non-uniformity of coloration. A high rating is highly desired and had been difficult to attain by printing with water-based inks onto media surfaces traditionally prepared to receive solvent based or toner-based inks. The non-uniformity of coloration is a result of ink drops either not able to spread uniformly on the media and/or due to adjacent ink drops combining and drying in an uncontrolled manner, leading to uneven pooling of inks which lead to unsightly distribution of the colorants. The phenomenon had been referred to by various terminologies such as coalescence, mottle, beading, or poor wetting. Good uniformity is particularly difficult with increasing ink coverage on the media.

Poor ink drop spread is manifested also in lower chromaticity or optical density in the printed image.

Foaming property of the inks was evaluated by partially filling a vial (30% of volume capacity) with the ink and shaking vigorously. The amount of foam and the ease of dissipation of the foam were taken into consideration. A rating of low foam indicates that either very little foaming had occurred or that foam rapidly dissipated within 10 minutes upon stopping. A rating of high foam indicates a significant head of foam that did not dissipate readily even after 10 minute after stopping.

### Discussion

Pairs of cyan and yellow inks were prepared with ingredients listed in Table 1 and 2. Results are summarized in Table 3. The printed image showed increasing image quality and chromaticity for inks containing polymer binder. Pair 1 had no binder and was inferior in printed quality compared to Pair 2 which had a low amount of binder. Pair 3 and 4 containing increasing level of binder showed larger improvement with the most preferred amount of binder being 3% or higher.

The binders used in Pairs 2-4 were neutralized with potassium. The binders in Pairs 5-8 were neutralized with organic amines. With similar levels of binder in the ink (Pair 5 compared to Pair 4) and (Pairs 6-8 compared to Pair 3), binders neutralized with organic amines gave improved image qualities with higher optical densities and chroma and greater uniformity of printed image. It is postulated that the organic amine-neutralized binder provide a better compatibility of the ink to the surfaces of coated media which are often regarded as hydrophobic.

Examples in Table 3 and Table 4 demonstrated the impact of surfactant choice on image quality. Better image quality was obtained from inks containing polymer binder with surfactants having an HLB value of about 8 or lower, and the best image quality with surfactants having an HLB value of about 5 or lower. Preferred surfactants are the ones without silicone or fluoro atoms. Inks containing fluoro surfactants or organo-silicone surfactants tend to have very high amount of foam which can cause material-handling and/or jet reliability problems. Furthermore, inks combining organo-silicone surfactants (e.g., Byk 348 and Dow 67 Additive) with binders and pigment dispersions showed a decrease in the surface tension stability of the surfactant upon storage.

TABLE 1

| | Pair 1 | | Pair 2 | | Pair 3 | | Pair 4 | |
|---|---|---|---|---|---|---|---|---|
| | Ink 1A | Ink 1B | Ink 2A | Ink 2B | Ink 3A | Ink 3B | Ink 4A | Ink 4B |
| Dispersion A | 4.0 | — | 4.0 | — | 4.0 | — | 4.0 | — |
| Dispersion B | — | 5.0 | — | 5.0 | — | 5.0 | — | 5.0 |
| Binder A | — | — | 2.0 | 1.5 | 4.0 | 3.0 | 6.0 | 6.0 |
| (potassium | | | | | | | | |
| neutralized) | | | | | | | | |
| Glycerol | 3.0 | 4.9 | 3.0 | 3.9 | 3.0 | 3.7 | 3.0 | 3.9 |
| Ethylene Glycol | 27.0 | 25.0 | 25.0 | 25.0 | 22.0 | 22.0 | 22.0 | 22.0 |
| Pyrrolidone | 10.0 | 10.0 | 10.0 | 10.0 | 10.0 | 10.0 | 10.0 | 10.0 |
| Glycol Ether | 3.0 | 3.0 | 3.0 | 3.0 | 3.0 | 3.0 | 3.0 | 3.0 |
| Dynol ™607 | 1.3 | 1.3 | 1.3 | 1.3 | 1.3 | 1.3 | 1.3 | 1.3 |

| | |
|---|---|
| DI Water | Balance to 100% |

Properties

| | | | | | | | | |
|---|---|---|---|---|---|---|---|---|
| Viscosity at 32 | 4.6 | 4.0 | 5.0 | 4.4 | 5.3 | 4.6 | 6.4 | 6.0 |
| degree °, | | | | | | | | |
| (centipoise) | | | | | | | | |
| Surface | 30 | 31 | 31 | 30 | 31 | 31 | 32 | 31 |
| Tension, | | | | | | | | |
| (dyne/cm2) | | | | | | | | |

TABLE 2

| | Pair 5 | | Pair 6 | | Pair 7 | | Pair 8 | |
|---|---|---|---|---|---|---|---|---|
| | Ink 5A | Ink 5B | Ink 6A | Ink 6B | Ink 7A | Ink 7B | Ink 8A | Ink 8B |
| Dispersion A | 4.0 | — | 4.0 | — | 4.0 | — | 4.0 | — |
| Dispersion B | — | 5.0 | — | 5.0 | — | 5.0 | — | 5.0 |
| Binder B (solid, | 6.0 | 6.0 | — | — | — | — | — | — |
| ammonia | | | | | | | | |
| neutralized) | | | | | | | | |
| Binder C (solid, | — | — | 4.0 | 3.0 | — | — | — | — |
| DMEA | | | | | | | | |
| neutralized) | | | | | | | | |
| Binder D (solid, | — | — | — | — | 4.0 | 3.0 | — | — |
| DBU | | | | | | | | |
| neutralized) | | | | | | | | |
| Binder E (solid, | — | — | — | — | — | — | 4.0 | 3.0 |
| DMIPA | | | | | | | | |
| neutralized) | | | | | | | | |
| Glycerol | 3.0 | 4.0 | 3.0 | 4.0 | 3.0 | 4.0 | 3.0 | 4.0 |
| Ethylene Glycol | 22.0 | 22.0 | 22.0 | 22.0 | 22.0 | 22.0 | 22.0 | 22.0 |
| Pyrrolidone | 10.0 | 10.0 | 10.0 | 10.0 | 10.0 | 10.0 | 10.0 | 10.0 |
| Glycol Ether | 3.0 | 3.0 | 3.0 | 3.0 | 3.0 | 3.0 | 3.0 | 3.0 |
| Dynol ™607 | 1.3 | 1.3 | 1.3 | 1.3 | 1.3 | 1.3 | 1.3 | 1.3 |

| | |
|---|---|
| DI Water | Balance to 100% |

Properties

| | | | | | | | | |
|---|---|---|---|---|---|---|---|---|
| Viscosity at 32 | 6.2 | 5.9 | 5.7 | 4.7 | 5.4 | 4.8 | 5.3 | 4.7 |
| degree Celsius, | | | | | | | | |
| centipoise | | | | | | | | |
| Surface Tension, | 31 | 32 | 32 | 30 | 31 | 31 | 31 | 31 |
| dyne/cm2 | | | | | | | | |

TABLE 3

| | Pair 1 | Pair 2 | Pair 3 | Pair 4 | Pair 5 | Pair 6 | Pair 7 | Pair 8 |
|---|---|---|---|---|---|---|---|---|
| Optical Density | 1.62 | 1.70 | 1.81 | 1.87 | 2.03 | 2.07 | 2.02 | 2.05 |
| of secondary | | | | | | | | |
| color green on | | | | | | | | |
| Terra Press | | | | | | | | |
| Silk | | | | | | | | |
| Optical Density | 1.85 | 2.02 | 2.11 | 2.03 | 2.30 | 2.32 | 2.28 | 2.30 |
| of secondary | | | | | | | | |
| color green on | | | | | | | | |
| OK Topcoat | | | | | | | | |
| Plus | | | | | | | | |
| Chroma of | 70 | 74 | 78 | 81 | 85 | 81 | 82 | 83 |
| secondary color | | | | | | | | |
| green on Terra | | | | | | | | |
| Press Silk | | | | | | | | |
| Chroma of | 78 | 82 | 85 | 85 | 94 | 89 | 90 | 91 |
| secondary color | | | | | | | | |
| green on OK | | | | | | | | |
| Topcoat Plus | | | | | | | | |
| Overall | 1.0 | 2.0 | 2.5 | 3.5 | 4.0 | 4.0 | 4.0 | 4.0 |
| uniformity of | | | | | | | | |
| printed images | | | | | | | | |
| on coated | | | | | | | | |
| media* | | | | | | | | |

*Uniformity of printed image evaluated for Stora Enso Terra Press Silk, Oji OK Topcoat Plus, UPM Finesse Gloss, Mohawk Gloss 50/10, Stora Enso LumiArt Gloss, and Oji New Age coated papers.

TABLE 4

| Ink | A | B | C | D | E | F | G | H | I | J |
|---|---|---|---|---|---|---|---|---|---|---|
| Dispersion C | 4.0 | 4.0 | 4.0 | 4.0 | 4.0 | 4.0 | 4.0 | 4.0 | 4.0 | 4.0 |
| Polymer Binder | 4.0 | 4.0 | 4.0 | 4.0 | 4.0 | 4.0 | 4.0 | 4.0 | 4.0 | 4.0 |
| A solids | | | | | | | | | | |
| Glycerol | 3.3 | 3.3 | 3.3 | 3.3 | 3.3 | 3.3 | 3.3 | 3.3 | 3.3 | 3.3 |
| Ethylene | 22.0 | 22.0 | 22.0 | 22.0 | 22.0 | 22.0 | 22.0 | 22.0 | 22.0 | 22.0 |
| Glycol | | | | | | | | | | |
| Glycol Ether | 3.0 | 3.0 | 3.0 | 3.0 | 3.0 | 3.0 | 3.0 | 3.0 | 3.0 | 3.0 |
| Pyrrolidone | 10.0 | 10.0 | 10.0 | 10.0 | 10.0 | 10.0 | 10.0 | 10.0 | 10.0 | 10.0 |
| Surfynol ™104 | 1.0 | | | | | | | | | |
| (HLB 4) | | | | | | | | | | |
| Surfynol ™ 420 | | 1.0 | | | | | | | | |
| (HLB 4) | | | | | | | | | | |
| Dynol ™ 810 | | | 1.0 | | | | | | | |
| (HLB 4) | | | | | | | | | | |
| Dynol ™ 607 | | | | 1.0 | | | | | | |
| (HLB 8) | | | | | | | | | | |
| Dow | | | | | 1.0 | | | | | |
| 67Additive | | | | | | | | | | |
| (HLB 11.5) | | | | | | | | | | |
| Surfynol ™ 465 | | | | | | 1.0 | | | | |
| (HLB 13) | | | | | | | | | | |
| Carbowet ™ 144 | | | | | | | 1.0 | | | |
| (HLB 14.4) | | | | | | | | | | |
| Surfynol ™ 485 | | | | | | | | 1.0 | | |
| (HLB 17) | | | | | | | | | | |
| Pluronic ™ F38 | | | | | | | | | 1.0 | |
| (HLB ~25) | | | | | | | | | | |
| Capstone ™ | | | | | | | | | | 0.5 |
| FS-35 | | | | | | | | | | |

| | |
|---|---|
| DI water | Balance to 100% |

Properties

| | | | | | | | | | | |
|---|---|---|---|---|---|---|---|---|---|---|
| Initial | 31 | 31 | 30 | 32 | 26 | 35 | 36 | 39 | 41 | 20 |
| Surface | | | | | | | | | | |
| Tension, | | | | | | | | | | |
| dynes/cm2 | | | | | | | | | | |
| Surface | 31 | 31 | 30 | 32 | 33 | 35 | 37 | 39 | 41 | 20 |
| Tension | | | | | | | | | | |
| after 2 | | | | | | | | | | |
| weeks at 70 | | | | | | | | | | |
| degrees | | | | | | | | | | |
| Celsius | | | | | | | | | | |
| Surface | Yes | Yes | Yes | Yes | No | Yes | Yes | Yes | Yes | Yes |
| Tension | | | | | | | | | | |
| Stability | | | | | | | | | | |
| Foaming | Low | Low | Low | High | High | High | High | High | Low | High |
| Property | Foam | Foam | Foam | Foam | Foam | Foam | Foam | Foam | Foam | Foam |

TABLE 5
(Optical Density Property)

| Ink | A | B | C | D | E | F | G | H | I | J |
|---|---|---|---|---|---|---|---|---|---|---|
| Xerox 4200 | 0.84 | 0.84 | 0.83 | 0.83 | 0.80 | 0.83 | 0.81 | 0.83 | 0.81 | 0.82 |
| Business | | | | | | | | | | |
| plain paper | | | | | | | | | | |
| Mohawk | 1.35 | 1.36 | 1.32 | 1.33 | 1.38 | 1.20 | 1.05 | 1.01 | 0.97 | 1.33 |
| Gloss 50/10 | | | | | | | | | | |
| OK Topcoat | 1.21 | 1.21 | 1.19 | 1.14 | 1.22 | 1.04 | 0.96 | 0.94 | 0.90 | 1.15 |
| Plus | | | | | | | | | | |
| TerraPress | 1.06 | 1.04 | 1.05 | 1.04 | 1.05 | 0.95 | 0.88 | 0.85 | 0.82 | 1.02 |
| Silk Offset | | | | | | | | | | |
| UPM | 1.24 | 1.20 | 1.20 | 1.16 | 1.21 | 1.07 | 0.98 | 0.97 | 0.93 | 1.23 |
| Finesse | | | | | | | | | | |
| Gloss | | | | | | | | | | |
| Average | 1.21 | 1.20 | 1.19 | 1.17 | 1.22 | 1.07 | 0.97 | 0.94 | 0.91 | 1.18 |
| Optical | | | | | | | | | | |
| Density on | | | | | | | | | | |
| Coated | | | | | | | | | | |
| Papers | | | | | | | | | | |

TABLE 6

| Ink | K | L | M | N | O | P | Q |
|---|---|---|---|---|---|---|---|
| Dispersion A | 2.5 | 2.5 | 2.5 | 2.5 | 2.5 | 2.5 | 2.5 |
| Binder F | 6.0 | 6.0 | 6.0 | 6.0 | 6.0 | 6.0 | 6.0 |
| solids | | | | | | | |
| Glycerol | 2.0 | 2.0 | 2.0 | 2.0 | 2.0 | 2.0 | 2.0 |
| Alkane diol | 24.0 | 24.0 | 24.0 | 24.0 | 24.0 | 24.0 | 24.0 |
| Glycol ether | 10.0 | 10.0 | 10.0 | 10.0 | 10.0 | 10.0 | 10.0 |
| Surfynol ™ | 2.0 | — | — | — | — | — | — |
| 104 | | | | | | | |
| (HLB 4) | | | | | | | |
| Surfynol ™ | — | 2.0 | — | — | — | — | — |
| SEF | | | | | | | |
| (HLB 4 -5) | | | | | | | |
| Surfynol ™ | — | — | 2.0 | — | — | — | — |
| 420 | | | | | | | |
| (HLB 4) | | | | | | | |
| Surfynol ™ | — | — | — | 2.0 | — | — | — |
| 440 | | | | | | | |
| (HLB 8) | | | | | | | |
| Surfynol ™ | — | — | — | — | 2.0 | — | — |
| 465 | | | | | | | |
| (HLB 13) | | | | | | | |
| Surfynol ™ | — | — | — | — | — | 2.0 | — |
| 485 | | | | | | | |
| (HLB 17) | | | | | | | |
| BYK ™ 348 | — | — | — | — | — | — | 0.5 |
| D. I. Water | Balance to 100% | | | | | | |
| Surface | 30 | 30 | 30 | 30 | 34 | 37 | 26 |
| Tension, | | | | | | | |
| dyne/cm2 | | | | | | | |
| Optical | 2.42 | 2.45 | 2.44 | 2.36 | 2.15 | 1.64 | 2.37 |
| Density on OK | | | | | | | |
| Topcoat Plus | | | | | | | |
| coated paper | | | | | | | |
| Uniformity of | 4.0 | 4.0 | 4.0 | 3.0 | 1.5 | 1.0 | 4.0 |
| image on OK | | | | | | | |
| Topcoat Plus | | | | | | | |
| coated paper | | | | | | | |
| Foaming | Low | Low | Low | Low | — | — | High |
| Property | Foam | Foam | Foam | Foam | | | Foam |

What is claimed is:

1. An inkjet ink for printing on a coated media substrate, said inkjet ink comprising a colorant, an aqueous vehicle, a polymeric binder, and a non-ionic surfactant, wherein said binder is dispersed in the aqueous vehicle and is present at an amount of greater than 3% by weight based on the weight of the ink.

2. The ink of claim 1, wherein said binder is a polyurethane.

3. The ink of claim 2, wherein said polyurethane is cross-linked.

4. The ink of claim 1, wherein said binder is acrylics.

5. The ink of claim 1, wherein said binder is neutralized by an amine.

6. The ink of claim 1, wherein said colorant is an organic pigment.

7. The ink of claim 1, wherein said colorant is a self-dispersing pigment.

8. The ink of claim 1, wherein said colorant is dispersed by a polymeric dispersant.

9. The ink of claim 1, wherein said ink further comprises a co-solvent at an amount of greater than 25% based the total weight of the ink.

10. The ink of claim 9, wherein said ink further comprises a co-solvent at an amount of greater than 30% based the total weight of the ink.

11. The ink of claim 1, wherein said non-ionic surfactant has an HLB value of 8 or lower.

12. The ink of claim 11, wherein said non-ionic surfactant has an HLB value of 4 or lower.

13. The ink of claim 1, wherein said ink has a surface tension of between 18 and 35 dyne/cm.

14. The ink of claim 1, wherein said ink has a viscosity of between 3 centipoise and 8 centipoise.
